(19) United States
(12) Patent Application Publication
(10) Pub. No.: US 2005/0270918 A1
(43) Pub. Date: Dec. 8, 2005

(54) OPTICAL DISC DRIVE CAPABLE OF GENERATING DIGITAL SERVO CONTROL SIGNALS AND METHOD THEREOF

(76) Inventors: Kuang-Yu Yen, Tai-Chung City (TW); Chen-Hsing Lo, Tao-Yuan Hsien (TW); Shih-Chung Chiang, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 10/908,818

(22) Filed: May 27, 2005

(30) Foreign Application Priority Data
Jun. 4, 2004 (TW) 093116161

(51) Int. Cl. G11B 7/00

(52) U.S. Cl. 369/44.27; 369/44.28; 369/44.34

(57) ABSTRACT

An optical disc drive and related method for accessing an optical disc. The optical disc drive includes a pickup module, a digital pre-amp module, a servo control module, and an actuator module. The pickup module generates a plurality of digital receiving signals according to a light beam reflected off the optical disc. Coupled to the pickup module, the digital pre-amp module generates a digital servo control signal according to the plurality of digital receiving signals. Coupled to the digital pre-amp module, the servo control module generates a driving signal according to the digital servo control signal. Coupled to the servo control module, the actuator module controls a position of a focal point of a laser light generated by the pickup module according to the driving signal.

### BACKGROUND OF THE INVENTION

1. Field of the Invention

The present invention relates to optical disc drives, and more particularly to an optical disc drive generating digital servo control signals.

2. Description of the Prior Art

Optical disc drives are devices reading data from optical discs or writing data onto optical discs. No matter whether a writing task or a reading task is performed, the optical disc drive outputs a laser light onto an optical disc through a pickup head and generates servo control signals according to a light beam reflected off the optical disc. The servo control signals are used in servo control process. A focus error signal FE and a tracking error signal TE are the two most frequently used servo control signals. With the focus error signal FE, the optical disc drive can maintain a focal point of the laser light outputted by the pickup head on a specific layer of the optical disc. With the tracking error signal TE, the optical disc drive can maintain the focal point of the laser light on a data track of the optical disc.

FIG. 1 shows a schematic diagram of a conventional optical disc drive 100 (only components relating to the servo control process are shown). The optical disc drive 100 comprises a pickup head 110, an analog pre-amp module 120, an ADC 130, a compensator module 160, a DAC 170, a driver module 180, and an actuator module 190.

The pickup head 110 outputs a laser light onto the optical disc 50 and a photodiode of the pickup head 110 generates a plurality of receiving signals in analog form, such as signal A, B, C, D, E, and F, according to a light beam reflected off the optical disc 50. The analog pre-amp module 120 comprises analog circuits for processing the receiving signals A-F to generate servo control signals in analog form, such as the FE signal, the TE signal, and the CE (central error) signal. FIG. 2 shows a detailed schematic diagram of the analog pre-amp module 120 of FIG. 1.

The compensator module 160 is a digital signal processor (DSP). After the analog servo control signals are converted into digital form by the ADC 130, the compensator module 160 generates a digital compensating signal according to the digital servo control signals. After the digital compensating signal is converted into analog form by the DAC 170, the driver module 180 generates a driving signal according to the analog compensating signal. Then, the actuator module 190 processes the servo control task adequately according to the driving signal.

There are many examples for the actuator module 190, such as a spindle motor for rotating the optical disc 50, a sled motor for moving the pickup head 110, or a voice coil set on the pickup head 110 for moving an object lens up/down. Each of these components could be driven by a specific driving signal generated by the driver module 180.

The mentioned conventional optical disc drive uses analog circuits as the pre-amp module 120, and analog operations are executed by the pre-amp module 120 to generate servo control signal(s) in analog form. However, analog circuits consume more IC area and a high yield rate is hard to achieve with analog circuits. It is also hard to design firmware for analog circuits.

### SUMMARY OF THE INVENTION

It is therefore one of objectives of the present invention to provide an optical disc drive and a corresponding method generating digital servo control signals.

It is therefore one of objectives of the present invention to provide an optical disc drive and a method generating digital servo control signals. It is easier to design firmware used in the optical disc drive.

It is therefore one of objectives of the present invention to provide an optical storage controller. The optical storage controller has a smaller size.

According to the claimed invention, an optical disc drive is disclosed. The optical disc drive includes a pickup module, a digital pre-amp module, a servo control module, and an actuator module. The pickup module generates a plurality of digital receiving signals according to a light beam reflected off the optical disc. The digital pre-amp module generates a digital servo control signal according to the digital receiving signals. The servo control module generates a driving signal according to the digital servo control signal. The actuator module controls the position of a focal point of the laser light according to the driving signal.

According to an embodiment of the present invention, a digital servo signal generation apparatus used in an optical disc drive is disclosed. The optical disc drive includes a pickup head for generating a plurality of analog receiving signals. The apparatus includes a signal conversion module and a digital pre-amp module. The signal conversion module generates a plurality of digital receiving signals according to the analog receiving signals. The digital pre-amp module generates a digital servo control signal according to the digital receiving signals.

According another embodiment of the present invention, a servo control method used in an optical disc drive is disclosed. The optical disc drive includes a pickup head for accessing an optical disc. The method includes generating a plurality of analog receiving signals according to a light beam reflected off an optical disc. A plurality of digital receiving signals are generated according to the analog receiving signals. A digital servo control signal is generated according to the digital receiving signals. A driving signal is generated according to the digital servo control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a block diagram of a conventional optical disc drive.

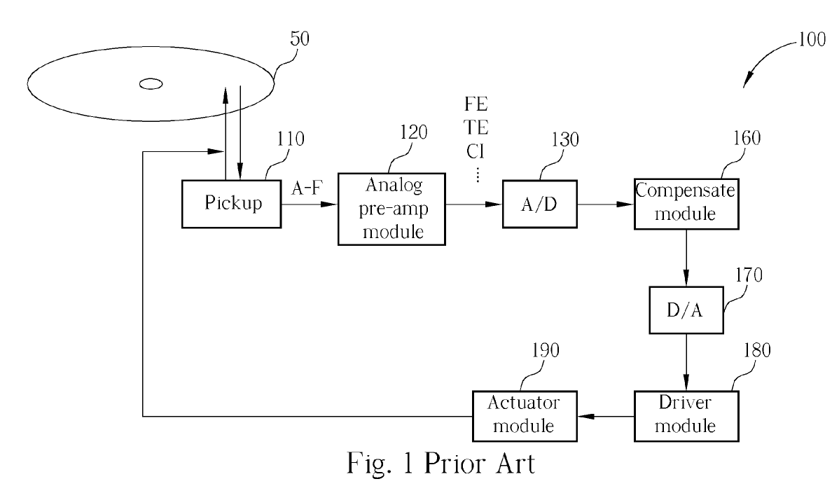

FIG. 2 shows a detailed block diagram of the analog pre-amp module shown in FIG. 1.

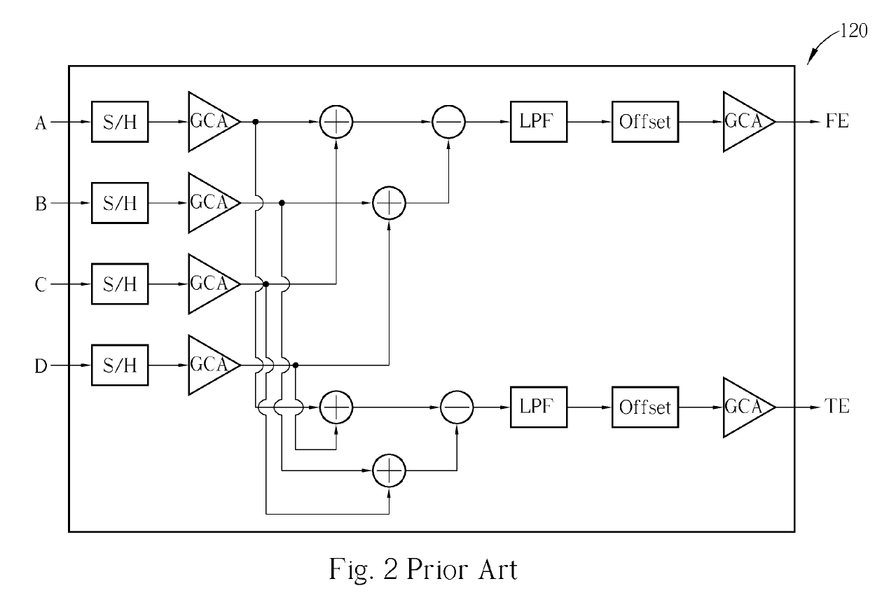

FIG. 3 shows a block diagram of an optical disc drive according to a preferred embodiment of the present invention.

FIG. 4 shows a block diagram of the pickup module and the digital pre-amp module shown in FIG. 3.

FIG. 5 shows a flowchart according to the present invention.

### DETAILED DESCRIPTION

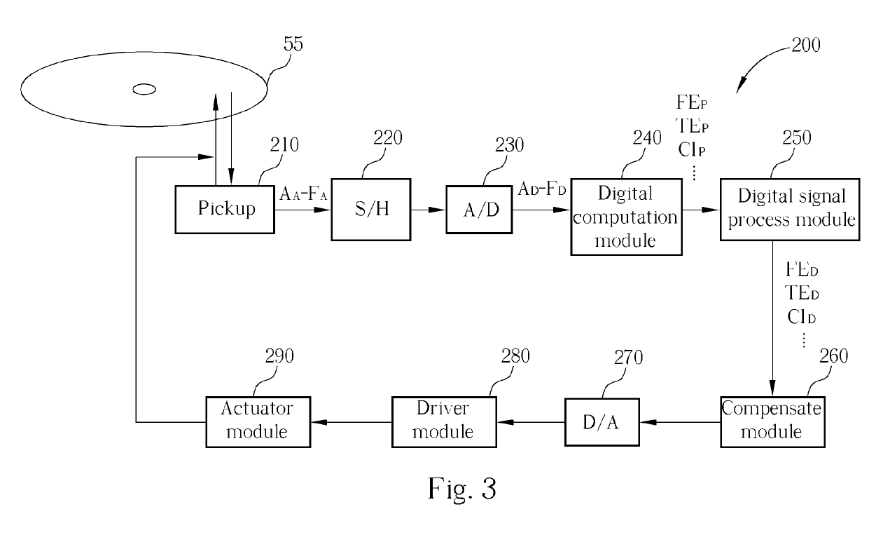

FIG. 3 shows an optical disc drive according to the present invention. The optical disc drive 200 is for accessing an optical disc 55. The optical disc drive 200 comprises a pickup module, a digital pre-amp module, a servo control module, and an actuator module 290.

The pickup module comprises a pickup head 210 and a signal conversion module. The signal conversion module includes a sample and hold module (S/H module) 220 and an analog-to-digital conversion module (A/D module) 230. The pickup head 210 outputs a laser light onto the optical disc 55, and a photodiode therein generates a plurality of analog receiving signals A_{A}−F_{A} according to a light beam reflected off the optical disc 55. After the S/H module 220 and the A/D module 230 process the analog receiving signals A_{A}−F_{A}, the signal conversion module outputs a plurality of digital receiving signals A_{D}−F_{D} accordingly. Please note that the A/D module 230 may include a plurality of analog to digital converters (ADCs) each for converting an analog receiving signal into a digital receiving signal, or may include a single ADC which is switched properly to respectively convert the analog receiving signals into the digital receiving signals.

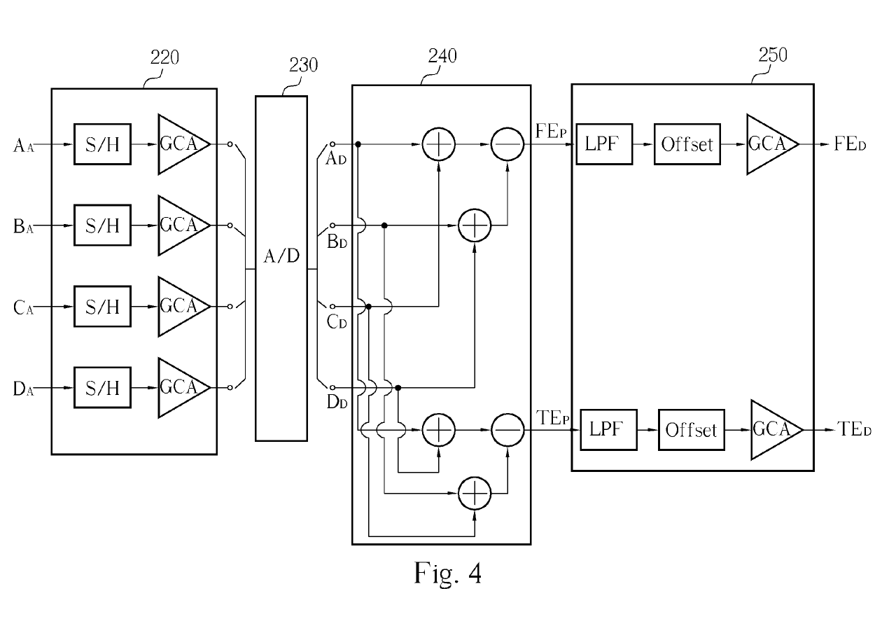

The digital pre-amp module comprises a digital computation module 240 and a digital signal processing (DSP) module 250. The digital computation module 240 generates initial digital servo signals FE_{P}, TE_{P}, CI_{P}, etc. according to the digital receiving signals A_{D}−F_{D}. For example, if the optical disc 55 is a compact disc (CD), the digital computation module 240 could subtract a signal (B_{D}+D_{D}) from another signal (A_{D}+C_{D}) to generate the initial digital servo signal FE_{P}. The digital computation module 240 could also subtract the signal F_{D} from the signal E_{D} to generate the initial digital servo signal TE_{P}. After the initial digital servo signals FE_{P}, TE_{P}, CI_{P} are generated, the DSP module 250 then filters, amplifies, and calibrates the offset of the initial digital servo signals FE_{P}, TE_{P}, CI_{P} to generate the digital servo control signals FE_{D}, TE_{D}, CI_{D}. Hence, the signal conversion module and the digital pre-amp module as a whole could be called a “digital servo signal generation module”. In addition, an embodiment of the pickup module and the digital pre-amp module is shown in FIG. 4. In an embodiment, the digital computation module 240 includes a plurality of digital adders. In an embodiment, the DSP module 250 includes a low pass filter (LPF), an offset calibrator, and a gain control amplifier (GCA).

The servo control module comprises a compensator module 260, a digital-to-analog conversion module (D/A module) 270, and a driver module 280. A digital signal processor (DSP) is an example for the compensator module 260, which generates digital compensating signals according to the digital servo control signals FE_{D}, TE_{D}, CI_{D}. Next, the D/A module 270 converts the digital compensating signals into analog form and the driver module 280 generates a plurality of driving signals according to the analog compensating signals. Then the actuator module 290 processes servo control tasks properly according to the driving signals. For example, the actuator module 290 could adjust the position of the laser light outputted by the pickup head 21 0 according to the driving signals generated by the driver module 280.

Please note that there are many examples for the actuator module 290, such as a spindle motor for rotating the optical disc 55, a sled motor for moving the pickup head 210 radially, or a voice coil for moving the pickup head 210 up/down. Each of these elements is driven by a specific driving signal generated by the driver module 280.

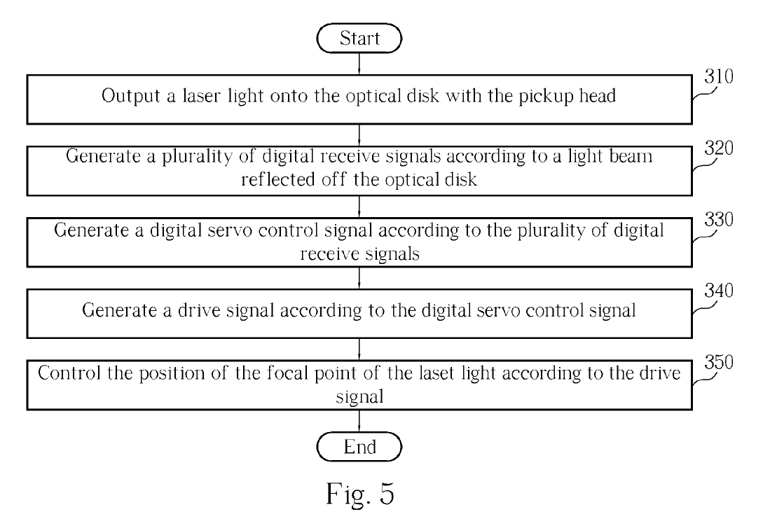

FIG. 5 shows a flowchart of a servo control method according to the present invention. The steps shown in FIG. 5 are as follows.

Step 310: Output a laser light onto the optical disc.

Step 320: Generate a plurality of digital receiving signals according to a light beam reflected off the optical disc. In a preferred embodiment, this step includes three sub-steps. First, use the pickup head to generate a plurality of analog receiving signals. Next, sample and hold the plurality of analog receiving signals to generate a plurality of sampled signals. Then, convert the sampled signals into the plurality of digital receiving signals.

Step 330: Generate a digital servo control signal according to the digital receiving signals. In a preferred embodiment, this step includes two sub-steps. First, generate an initial digital servo signal according to the digital receiving signals. Then, generate the digital servo control signal according to the initial digital servo signal. For example, this sub-step could perform filtering, offset-calibrating, and amplifying on the initial digital servo signal to generate the digital servo control signal.

Step 340: Generate a driving signal according to the digital servo control signal. In a preferred embodiment, this step includes three sub-steps. First, generate a digital compensating signal according to the digital servo control signal. Next, convert the digital compensating signal into an analog compensating signal. Then, generate the driving signal according to the analog compensating signal.

Step 350: Control the position of a focal point of the laser light with the driving signal. For example, the driving signal could be used to drive a spindle motor of the optical disc drive in order to control the spin speed of the optical disc, or be used to drive a sled motor of the optical disc drive in order to control the position of the pickup head, or be used to drive a voice coil of the pickup head in order to control the position of an object lens of the pickup head.

Those skilled in the art will readily observe that numerous modifications and alterations of the device and method may be made while retaining the teachings of the invention. Accordingly, the above disclosure should be construed as limited only by the metes and bounds of the appended claims.

1. An optical disc drive comprising:
a pickup module for accessing an optical disc to generate a plurality of analog receiving signals and converting the plurality of analog receiving signals into a plurality of digital receiving signals;
a digital pre-amp module coupled to the pickup module for generating a digital servo control signal according to the plurality of digital receiving signals;
a servo control module coupled to the digital pre-amp module for generating a driving signal according to the digital servo control signal; and
an actuator module coupled to the servo control module for controlling the pickup module according to the driving signal.

2. The optical disc drive of claim 1 wherein the pickup module comprises:
a pickup head for outputting a laser light onto the optical disc and generating the plurality of analog receiving signals according to a light beam reflected off the optical disc; and
a signal conversion module coupled to the pickup head for converting the plurality of analog receiving signals into the plurality of digital receiving signals.

3. The optical disc drive of claim 2 wherein the signal conversion module comprises:
a sample and hold module (S/H module) coupled to the pickup head for sampling and holding the plurality of analog receiving signals to generate a plurality of sampled signals; and
an analog-to-digital conversion module (A/D module) coupled to the S/H module for converting the plurality of sampled signals into the plurality of digital receiving signals.

4. The optical disc drive of claim 1 wherein the actuator module controls a position of a focal point of a laser light generated by the pickup module.

5. The optical disc drive of claim 1 wherein the digital pre-amp module comprises:
a computation module coupled to the pickup module for generating an initial digital servo signal according to the plurality of digital receiving signals; and
a signal processing module coupled to the computation module for generating the digital servo control signal according to the initial digital servo signal.

6. The optical disc drive of claim 5 wherein the computation module comprises a plurality of adders.

7. The optical disc drive of claim 5 wherein the signal processing module comprises at least one of a filter, an offset calibrator, and an amplifier.

8. The optical disc drive of claim 1 wherein the servo control module comprises:
a compensator module coupled to the digital pre-amp module for generating a digital compensating signal according to the digital servo control signal;
a digital-to-analog converter (DAC) coupled to the compensator module for converting the digital compensating signal into an analog compensating signal; and
a driver module coupled to the DAC for generating the driving signal according to the analog compensating signal.

9. A digital servo signal generation device used in an optical disc drive, the optical disc drive comprising a pickup head for generating a plurality of analog receiving signals, the device comprising:
a signal conversion module coupled to the pickup head for generating a plurality of digital receiving signals according to the plurality of analog receiving signals; and
a digital pre-amp module coupled to the signal conversion module for generating a digital servo control signal according to the plurality of digital receiving signals.

10. The device of claim 9 wherein the signal conversion module comprises:
a sample and hold module (S/H module) coupled to the pickup head for sampling and holding the plurality of analog receiving signals to generate a plurality of sampled signals; and
an analog-to-digital conversion module (ADC module) coupled to the S/H module for converting the plurality of sampled signals into the plurality of digital receiving signals.

11. The device of claim 9 wherein the digital pre-amp module comprises:
a computation module coupled to the signal conversion module for generating an initial digital servo signal according to the plurality of digital receiving signals; and
a signal processing module coupled to the computation module for generating the digital servo control signal according to the initial digital servo signal.

12. The optical disc drive of claim 9 wherein the digital pre-amp module comprises a computation module which comprises a plurality of digital adders.

13. The optical disc drive of claim 9 wherein the digital pre-amp module comprises a signal processing module which comprises at least one of a low pass filter, an offset calibrator, and an amplifier.

14. A servo control method used in an optical disc drive, the optical disc drive comprising a pickup head for accessing an optical disc to generate a plurality of analog receiving signals, the method comprising:
converting the plurality of analog receiving signals to produce a plurality of digital receiving signals;
generating a digital servo control signal according to the plurality of digital receiving signals;
generating a driving signal according to the digital servo control signal; and
controlling the pickup head according to the driving signal.

15. The method of claim 14 wherein the driving signal is used for controlling a position of a focal point of a laser light generated by the pickup head.

16. The method of claim 14 wherein the step for generating the digital servo control signal comprises:
generating an initial digital servo signal according to the plurality of digital receiving signals; and
generating the digital servo control signal according to the initial digital servo signal.

17. The method of claim 16 wherein the step for generating the digital servo control signal further comprises at least one processing step of filtering, offset-calibrating, and amplifying the initial digital servo signal to generate the digital servo control signal.

18. The method of claim 14 wherein the step for generating the driving signal comprises:
generating a digital compensating signal according to the digital servo control signal;
converting the digital compensating signal into an analog compensating signal; and
generating the driving signal according to the analog compensating signal.
